(19) United States
(12) Patent Application Publication
(10) Pub. No.: US 2005/0167127 A1
(43) Pub. Date: Aug. 4, 2005

(54) Gutter scoop

(76) Inventor: Stephen Handley, Barrie (CA)

Correspondence Address: DENNISON ASSOCIATES, 133 RICHMOND STREET WEST, SUITE 301, TORONTO, ON, M5H 2L7, CA

(21) Appl. No.: 10/759,043

(22) Filed: Jan. 20, 2004

(51) Int. Cl. A01B 1/00

(52) U.S. Cl. 172/371

(57) ABSTRACT

A gutter scoop includes a first “U” shaped scoop with a rearwardly extending elongate handle. The scoop is open at the front and closed at a rear portion thereof. A lower surface of the handle when invented defines a second smaller “U” shaped scoop. This second scoop is effective for cleaning smaller creases and clearing of clogged downspouts or discharge locations. In a preferred embodiment each scoop includes gradient lines defining specified volumes.

### FIELD OF THE INVENTION

The present invention is directed to a cleaning tool and in particular, to a cleaning tool having two separate scoop portions. In a preferred embodiment, the tool is a measurement and cleaning tool.

### BACKGROUND OF THE INVENTION

Many different approaches for cleaning of eavestroughs or gutters have been proposed and these solutions have met with varying degrees of success. For example, it is common to provide a screen or shield across the top surface of the eavestrough gutter in an effort to prevent debris such as leaves from entering the gutter and clogging the same. Unfortunately, many of these shields and screens become clogged and require cleaning or the gutter fails to act in its intended manner.

In direct contradiction to the various approaches for providing a cover for an eavestrough, a number of systems have provided a specialized tool for removing of debris from the gutters. Examples of such hand tools include the gutter scoop shown in U.S. Pat. No. 4,640,540 which includes flexible sidewalls which can conform to the shape of the gutter and assist in removing the debris from the gutters. More recently, a venting gutter scoop has been proposed in U.S. Published Application 2002/0014025. These gutter scoops include a large open “U” shaped scooper with a rearwardly extending handle. The user pushes the scoop along the gutter and leaves and other debris accumulate within the scoop for manual removal from the eavestrough and scoop.

There are also a number of proposals where the eavestrough can be cleaned from the ground level. These proposals include various types of scoop members provided on extension handles which are moved along the gutter and the leaves and other debris are removed. Other arrangements have included blowing of air into the gutter for removing of leaves as well as the blowing of water.

The attempts to mechanize and provide the ability to remove the leaves from the ground level result in the structure becoming quite complicated and not entirely satisfactory. In addition, the actual removal of the leaves from the gutter can cause an overflow of the debris and/or stagnant water on an exterior surface of the eavestrough and require cleaning. For many of these reasons and also for convenience, a hand tool where the user is adjacent the eavestrough on a ladder or on the roof in close proximity to the eavestrough remains the most common and accepted approach. The present invention provides an improved hand tool and a hand tool which can be used in other applications.

### SUMMARY OF THE INVENTION

A cleaning tool according to the present invention comprises a handle extending rearwardly from a first “U” shaped scoop which opens upwardly. This first “U” shaped scoop has opposed sidewalls connected by a bottom and an end wall. The first “U” shaped scoop is closed by the end wall and open at a front edge opposite to the end wall. The handle extends rearwardly from the end wall adjacent the upper edge of the first “U” shaped scoop. The handle is shaped to define a second “U” shaped scoop which opens downwardly with this second “U” shaped scoop being closed adjacent the first “U” shaped scoop. The second “U” shaped scoop is open at a distal end of the handle. The second “U” shaped scoop includes sidewalls, an endwall, and a bottom and is of a capacity which is only a small portion of the capacity of the first “U” shaped scoop.

The cleaning tool according to the present invention has the first and second “U” shaped scoops where the first “U” shaped scoop can act in the traditional manner for removing of leaves and other debris from an eavestrough gutter. The second scoop which is of a much smaller capacity is defined by the handle and is used by turning the first scoop to an inverted position. The second scoop is elongate and relatively narrow and allows effective cleaning of restricted areas of the gutter. It is also of great assistance in cleaning or partially unplugging of a downspout where the first scoop is of a size such that it cannot be inserted downwardly through the port in such a downspout. As can be appreciated, the handle is also effective in cleaning of the discharge of an eavestrough downspout or other pipe associated with such eavestrough systems.

According to an aspect of the invention, the handle which has the second scoop defined in the lower surface thereof extends above the first “U” shaped scoop whereby the scoops are vertically offset.

According to yet a further aspect of the invention, both the first scoop and the second scoop are of a similar shape.

According to yet a further aspect of the invention, the endwall of the first “U” shaped scoop merges with an endwall of the second “U” shaped scoop.

In yet a different aspect of the invention, the endwalls of the two scoops each includes a curved transition joining the respective endwall with the bottom of the respective scoop. This curved transition preferably includes thicker walls thereby strengthening the connection of the first scoop to the second scoop.

In yet a further aspect of the invention, the sidewalls of the second scoop adjacent the endwalls overlaps with the endwall of the first “U” shaped scoop to reinforce the connection of the handle to the first “U” shaped scoop. Basically, this overlap and extension of the sidewalls relative to the endwalls of the first “U” shaped scoop provides a gusset like reinforcement of the second scoop to the first scoop.

In a different aspect of the invention, the sidewalls of the second scoop adjacent the endwall significantly increases in thickness and reinforces the connection of the handle to the first “U” shaped scoop.

In yet a different aspect of the invention, the second scoop includes a tab at the front edge part with a cord for hanging of the tool when not in use.

In yet a further aspect of the invention, the sidewalls of each scoop are tapered towards the respective front edge and join with a rear portion of the respective scoop where the “U” shape is of a generally consistent height. Thus the sidewalls of each scoop taper downwardly towards the front edge of the respective scoop.

In yet a further aspect of the invention, each scoop includes gradient markings thereon whereby each scoop can be used as a measurement tool.

In a different aspect of the invention, each scoop includes at least two sets of gradient lines where each set of gradient lines defines a particular volume.

In a different aspect of the invention, each set of gradient lines is disposed at an angle to the respective scoop bottom. This allows a larger portion of the scoop to be used as a leveling line.

In yet a different aspect of the invention, each set of gradient lines include a gradient line adjacent the front edge of the respective scoop and an associated gradient line at the end walls of the scoop on the endwall or the adjacent sidewalls.

### BRIEF DESCRIPTION OF THE DRAWINGS

Preferred embodiments of the invention are shown in the drawings, wherein:

FIG. 1 is a perspective view of the cleaning scoop;

FIG. 2 is a bottom perspective view of the cleaning scoop;

FIG. 3 is a top view of the cleaning scoop; and

FIG. 4 is a side view of the cleaning scoop.

### DETAILED DESCRIPTION OF THE PREFERRED EMBODIMENTS

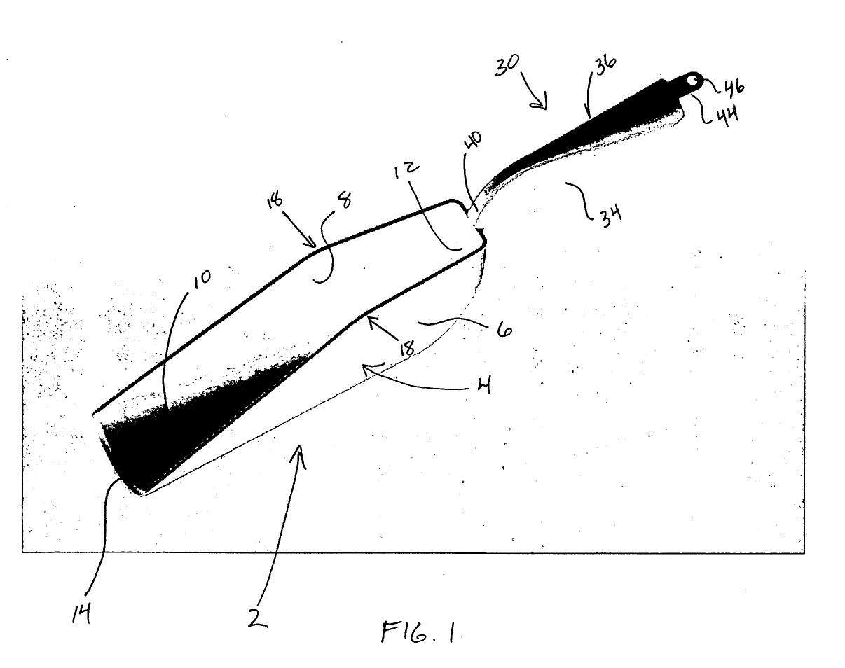

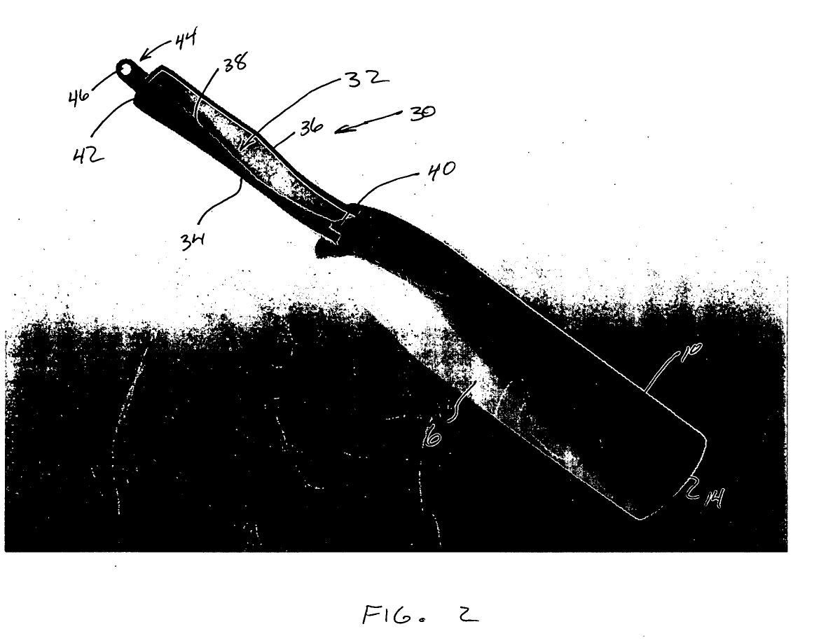

The cleaning tool 2, shown in FIGS. 1 and 2, has a first “U” shaped scoop 4 having sidewalls 6 and 8, a bottom 10 and an endwall 12. The “U” shaped scoop has a front edge 14 which has been tapered to improve the scraping feature of the front edge of the scoop. A handle 30 extends rearwardly from the scoop and allows a handgrip area for the user to force the first “U” shaped scoop along the eavestrough for accumulating debris within the scoop.

The first “U” shaped scoop 4 is of varying height. There is a transition point 18 of the sidewalls 6 and 8 where the “U” shaped section between transition point 18 and the handle is generally of a constant height, whereas the portion of the scoop forwardly of transition point 18 progressively decreases in height towards the front edge 14. The endwall 12 includes a curved transition such that the endwall joins with the bottom 10. This curved transition is shown in the side view of the cleaning tool shown in FIG. 4.

A bottom view of the handle 30 is shown in FIG. 2. The bottom surface of the handle defines a second “U” shaped scoop 32 which is elongate like the first “U” shaped scoop 4, however, it is of a much reduced width and also of reduced height. The second “U” shaped scoop has sidewalls 34 and 36, a bottom 38 and an endwall 40. The second “U” shaped scoop terminates at front edge 42 located on the distal end of the handle. A tab 44 projects from the front edge 42 and this tab includes a port 46. The tab 44 and the port 46 allow hanging of the tool when not in use. Preferably, the tab 44 is removable if it is not required.

The sidewalls 34 and 36 of the handle 30 also include a portion of generally consistent height of the “U” shaped section up to a transition point and then this height tapers downwardly to the front edge 42. As can be appreciated from a review of FIG. 1 and FIG. 2, the handle 30 provides a simple means for using the scoop in the traditional manner for removing of debris accumulated in the first “U” shaped scoop portion 4. For some cleaning applications, a smaller crevice type tool is needed, and in this case, the first “U” shaped scoop now becomes the handle and the cleaning tool is turned over defining a second narrow elongate scoop 32. This second “U” shaped scoop 32 is appropriate for cleaning small areas and is also suitable for freeing of downspout ports. The tab 44 can also provide a further narrow restriction for cleaning of other areas.

The first “U” shaped scoop 4 and the second “U” shaped scoop 32 are shown in FIG. 4 and are vertically offset. As can be seen, the handle 30 extends rearwardly of the first “U” shaped scoop and is positioned slightly above the first “U” shaped scoop. The user's hand is placed at an upper position and about the handle 30. The endwall 12 of the first scoop provides a smooth transition with the endwall 40 of the second scoop and each of these has a curved transition with their respective bottom. When the second “U” shaped scoop 32 is used, the user grasps the first “U” shaped section typically at a position beyond the transition point 18. This allows the user to place some of his fingers about the sidewalls of the first “U” shaped scoop. It can also be appreciated that the second scoop will project effectively downwardly from the user's hand and this provides some protection of the user's hand and is more convenient to use.

The sectional view of FIG. 4 illustrates the cooperation of sidewalls 34 and 36 of the second “U” shaped scoop 32 as they merge with and overlap the endwall 12 of the first “U” shaped portion.

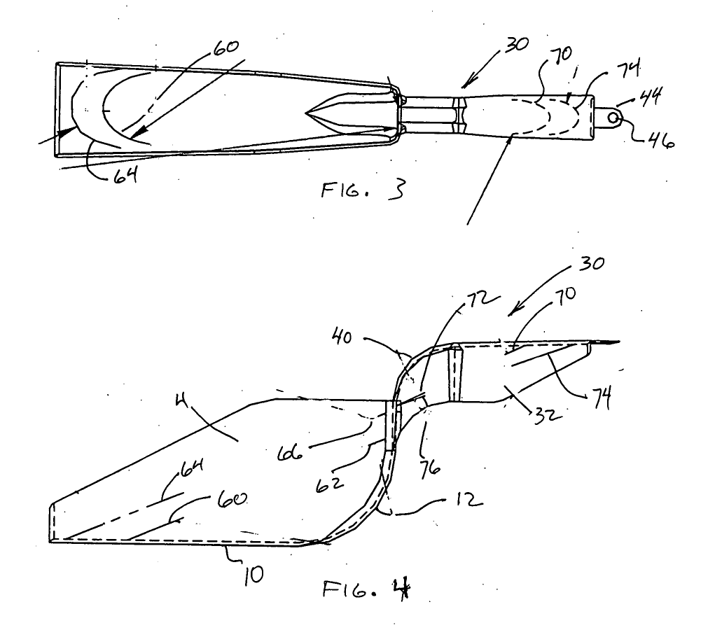

The top view of FIG. 3 illustrates that the sidewalls of the second scoop adjacent the endwall of the first “U” shaped scoop, are thickened to provide a strong transition and a gusset like reinforcement of the handle to the first “U” shaped scoop. The second “U” shaped scoop is also narrow width adjacent the endwall 40 to further stiffen the junction of the handle with the first scoop.

A further aspect of the cleaning tool can be appreciated from a review of FIGS. 3 and 4. Each of the “U” shaped scoops are provided with gradient lines to allow each scoop to act as a measuring tool. Gradient lines 60 and 62 are provided in the first “U” shaped scoop and form a set of gradient lines. This set of gradient lines would be for a particular volume and in this case, it should be shown for a half cup. A further set of gradient lines defined by gradient lines 64 and 66 are also provided in the first “U” shaped scoop and these lines define a volume below these lines and within the scoop of one cup. As can be appreciated, these gradient lines are disposed at an angle across the first “U” shaped scoop and are at an angle to the bottom 10. This provides a longer leveling line between the two gradient lines and provides good accuracy.

A similar approach is used with respect to the second “U” shaped scoop 32. In this case, there is a first set of gradient lines 70 and 72 which define a one tablespoon level. A second set of gradient lines 74 and 76 define a two tablespoon level. Once again, these gradient lines are disposed at an angle to the bottom wall of the second scoop and provide increased accuracy.

As can be appreciated, different volumes can be set and the invention is not limited to the particular volumes disclosed.

The gradient lines can either be small raised surfaces in each of the respective scoops or can be slight indentations. The main point is there will be a line which is visible and associated with this line will be some indication of the particular volume which can be measured by using the particular gradient line.

The cleaning tool 2 has been described with respect to an eavestrough cleaning application, however, the tool is useful in many other applications, particularly where measurement is desired. For example, the scoop is useful in dispersing salt or sand on a walkway. Therefore, the scoop is useful for non eavestrough cleaning applications.

Although various preferred embodiments of the present invention have been described herein in detail, it will be appreciated by those skilled in the art, that variations may be made thereto without departing from the spirit of the invention or the scope of the appended claims.

1. A cleaning tool comprising a handle extending rearwardly from a first “U” shaped scoop opening upwardly said first “U” shaped scoop having opposed sidewalls connected by a bottom and an end wall, said first “U” shaped scoop being closed by said end wall and open at a front edge opposite said endwall, said handle extending rearwardly from said endwall adjacent an upper edge of said first “U” shaped scoop; said handle being shaped to define a second “U” shape scoop opening downwardly, said second “U” shaped scoop being closed adjacent said first “U” shaped scoop and being open at a distal end of said handle; said second “U” shaped scoop including sidewalls, an endwall and a bottom defining a capacity which is only a small portion of the capacity of the first “U” shaped scoop.

2. A cleaning tool as claimed in claim 1 wherein said handle extends above said first “U” shaped scoop whereby said scoops are vertically offset.

3. A cleaning tool as claimed in claim 2 wherein said scoops are elongate and is of a similar shape.

4. A cleaning tool as claimed in claim 2 wherein said endwall of said first “U” shaped scoop merges with an endwall of said second “U” shaped scoop.

5. A cleaning tool as claimed in claim 4 wherein said endwalls each include a curved transition joining the respective endwall with the bottom of the respective scoop.

6. A cleaning tool as claimed in claim 4 wherein said sidewalls of said second scoop adjacent said endwalls overlap with the endwall of the first “U” shaped scoop to reinforce the connection of said handle to said first “U” shaped scoop.

7. A cleaning tool as claimed in claim 6 wherein said sidewalls of said second scoop adjacent said endwall significantly increase in thickness and reinforce the connection of said handle to said first “U” shaped scoop.

8. A cleaning tool as claimed in claim 1 wherein said second scoop includes at said front edge a tab with a port for hanging said tool when not in use.

9. A cleaning tool as claimed in claim 8 wherein said tab is removable.

10. A cleaning tool as claimed in claim 2 wherein the front edge of each scoop is tapered downwardly and towards the respective front edge.

11. A cleaning tool as claimed in claim 2 wherein said sidewalls of each scoop are tapered towards the respective front edge and join with a rear portion of the respective scoop where the “U” shape is of generally consistent height.

12. A cleaning tool as claimed in claim 8 wherein said tab projects beyond said front edge of said second scoop and forms a projection for removing debris from crevices.

13. A cleaning tool as claimed in claim 1 wherein each scoop includes gradient markings on an interior surface of the scoop whereby each scoop can be used as a measurement tool.

14. A cleaning tool as claimed in claim 13 wherein each scoop includes at least two sets of gradient lines where each set of gradient lines defines a particular volume.

15. A cleaning tool as claimed in claim 14 wherein each set of gradient lines are disposed at an angle to the respective scoop bottom.

16. A cleaning tool as claimed in claim 15 wherein each set of gradient lines include a gradient line adjacent said front edge of the respective scoop and associated gradient lines on at least one of the sidewalls or the endwall of the respective scoop.

17. A cleaning tool as claimed in claim 16 wherein said associated gradient lines are on said sidewalls adjacent said endwall.
